(19) United States
(12) Patent Application Publication
(10) Pub. No.: US 2026/0207431 A1
(43) Pub. Date: Jul. 23, 2026

(54) Method of providing a transport tub for medical active substance containers and filling method for filling a plurality of medical active substance containers

(71) Applicant: Presspart GmbH & Co. KG, Marsberg (DE)

(72) Inventors: Fredrik Andersson, Nidau (CH); Christoph Schulte, Marsberg (DE); Juanjo Forcadell, L'Arboc del Penedes, Tarragona (ES)

(21) Appl. No.: 19/138,340

(22) PCT Filed: Jul. 17, 2023
(86) PCT No.: PCT/EP2023/069785

§ 371 Date: Jun. 12, 2025

(30) Foreign Application Priority Data
Dec. 19, 2022 (EP) 22214680.5

(51) Int. Cl. A61J 1/16; A61J 1/06; A61J 1/14; B65B 3/00; B65B 7/28

(52) U.S. Cl. CPC A61J 1/16; A61J 1/065; A61J 1/1425; B65B 3/003; B65B 7/2842

(57) ABSTRACT

The invention relates to a transport tub (33) for medical active substance containers (1), in particular for transporting medical active substance containers (1) for filling medical active substances, wherein a first storage pallet (31) with a plurality of multi-part closure devices (2) and a second storage pallet (32) with a plurality of empty medical active substance containers (1) are accommodated in the transport tub (33) and the transport tub (33) is closed with a box lid (30) or a protective film (30). The multi-part closure devices (2) each have a sealing plug (20), a plug securing device (21) with a securing cage (210) and a protective cover (22), wherein the multi-part closure devices (2) are suitable for being pressed onto and engaging with collars (101) of bottle necks (10) of the medical active substance containers (1).

### TECHNICAL FIELD

The present invention relates to a transport tub with a first storage pallet and a second storage pallet with medical active substance containers, for filling medical active substances. The invention further relates to a filling method for filling a plurality of medical active substance containers and sealing them with associated closure devices.

### STATE OF THE ART

The aseptic storage and transportation of medical devices and medical active substances in medical active substance containers is of great importance in many areas of medicine. Of particular interest here are medical active substance containers in the form of medical injection vials, also known as “vials”, whereby liquid medical active substances are removed from such medical active substance containers with the aid of draw-up and/or application needles. Vaccine containers, vaccine vials or vaccine ampoules are a specific example of the medical active substance containers or vials in question.

The medical specialties of interest here, in which active substances are administered in such medical active substance containers, are in particular immunology, virology and oncology, but this is not to be understood as an exhaustive list.

The known vials or medical drug containers made of glass or plastic today have different shapes and multi-part closure devices. For example, EP2948122 describes a medical active substance container with a bottle neck and collar, where a rubber plug is partially inserted into the bottle neck and fixed there non-detachably by means of a retaining ring. The rubber plug has a sealing lip which is operatively connected to the inner surface of the bottle neck in a sealing manner. The retaining ring surrounds an edge of the rubber plug and a collar end bead and is formed from a metal sheet. By pressing the retaining ring onto the neck of the bottle and bending the edge of the retaining ring on the bottle side, the rubber plug cannot become detached from the medical active substance container and vaccines can be stored aseptically. Additional means are provided to form a plug securing device, which additionally enclose the rubber plug and the retaining ring, and a movable lid is attached. When the lid is opened and the area at the level of the center of the rubber plug is exposed, vaccine can be removed from the interior of the medical active substance container by piercing a draw-up and/or inoculation syringe or a draw-up and/or application needle through the thinner center of the rubber plug. In EP2948122, complex additional means are provided which go far beyond the simple securing of the rubber plug with a sheet metal ring. This design is technically complex and not suitable for mass production.

Due to the structural requirements according to EP2948122, the filling and sealing of the active substance containers is complex and not possible at the location of the filling systems. These steps must be carried out by specialists with specially designed equipment at filling stations, which means that the throughput is comparatively low.

### SUMMARY OF THE INVENTION

The present invention has set itself the object of providing a transport container which makes it possible to make large quantities of medical active substance containers available to the filling system in an effective manner, as well as corresponding closure devices by means of which the medical active substance containers can be sealed easily, without additional tools, directly after filling with active substance on site. In particular, a high degree of sterility and hygiene should also be ensured during transportation of the medical active substance containers.

The object underlying the invention is achieved by a transport tub with the features of claim 1 and by a filling method with the features of claim 11. Advantageous embodiments of the present invention are defined in the subclaims.

### BRIEF DESCRIPTION OF THE DRAWINGS

The object of the invention is described in detail below in connection with the attached figures. Necessary features, details and advantages of the invention result from this following description, whereby a preferred embodiment of the invention and some additional features or optional features are listed in detail.

Further features, details and advantages of the invention are shown in the following description of preferred embodiments of the invention and in the drawings. It shows:

FIG. 1a an exploded view of a bottle neck of a medical active substance container and a matching multi-part closure device with protective cover;

FIG. 1b a sectional view of the multi-part closure device with protective cover, placed on a bottle neck;

FIG. 1c a sectional view of the multi-part closure device with protective cover in the assembled state but without bottle neck;

FIG. 2a a perspective view of an option for the multi-part closure device with protective cover consisting of two rings;

FIG. 2b a sectional view of both rings mounted on a bottle neck;

FIG. 2c a sectional view of the assembled multi-part compact closure device with protective cover and the two rings attached to a bottle neck; and

FIG. 3 a sectional view of a transport container in which prefabricated storage pallets with several unfilled medical active substance containers and several non-attached multi-part closure devices are stored.

### DETAILED DESCRIPTION OF THE INVENTION

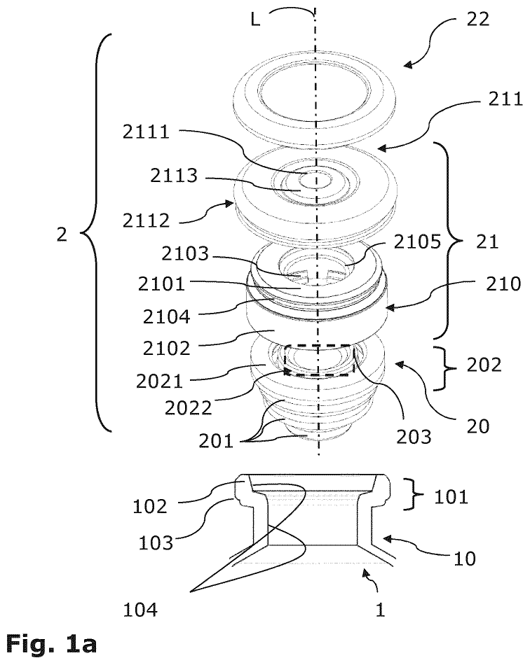

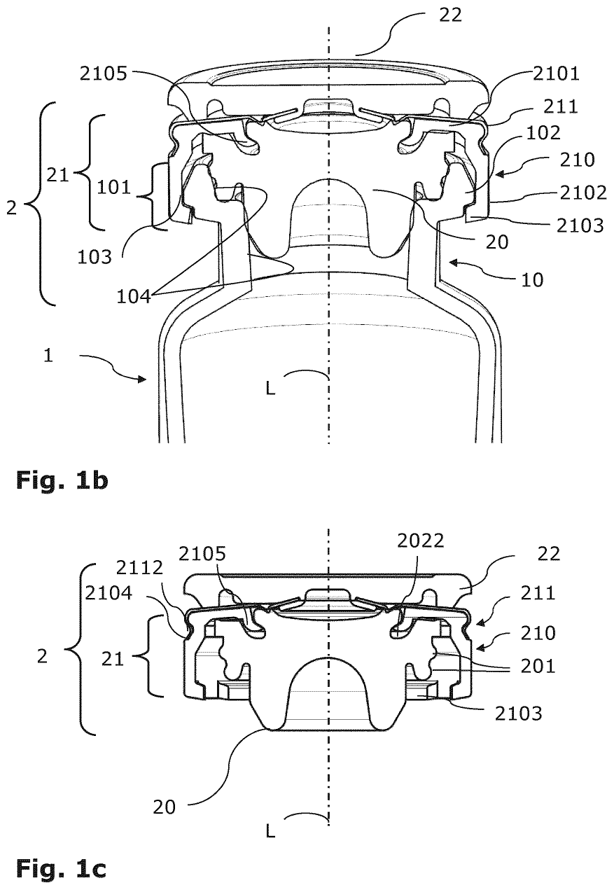

FIG. 1 shows a medical active substance container 1 with a multi-part compact closure device 2. Such medical active substance containers 1 or vials 1 can be referred to as injection vials, vaccine vials, vaccine ampoules, vaccine vials, multi-dose containers, medical vials for aseptic storage and removal of liquid active substances or vaccines and vaccine concentrates as medical active substances. These medical active substance containers 1 are made of glass or plastic and are commercially available in standardized sizes. After filling the medical active substance container 1, the multi-part closure device 2 is placed on a bottle neck 10. The multi-part closure device 2 must be mounted on the bottle neck 10 in such a way that it cannot be detached or removed without destroying it, so that no vaccine can escape from the medical active substance container 1 and no undesired access is possible.

The contents of the medical active substance container 1 are not shown here. Contamination of the interior of the medical active substance container 1 during transportation and storage must be avoided. After opening or first use of the contents of the medical active substance container 1, there are often only a few hours before the contents—for example a vaccine—become unusable.

The multi-part closure device 2 comprises at least one sealing plug 20 and a multi-part plug securing device 21, with which the sealing plug 20 can be detachably fastened to a collar 101 of the bottle neck 10. Due to the configuration of the plug securing device 21 presented here, the multi-part closure device 2 can be pressed onto the collar 101 in the direction of a longitudinal axis L of the medical active substance container 1 and means of the plug securing device 21 engage with the collar 101. In this way, the multi-part closure device 2 can be stored on the bottle neck 10 in a non-detachable manner and cannot be removed without destruction by simply pressing it onto the collar 101 in the direction of the longitudinal axis L of the medical active substance container 1 and means of the plug securing device 21 engage with the collar 101, so that no active substance can escape from the medical active substance container 1 and no undesired access is possible.

The closure device 2 is not intended for multiple use, i.e. the opening and closing of the closure device 2, but remains immobile and non-detachable after attachment to the collar 101 sealing the interior of the medical active substance container 1. A protective cover 22 is intended as an optional part of the multi-part closure device 2, which provides additional mechanical protection.

In FIG. 1a, the individual components are shown not yet assembled and are presented individually from bottom to top.

The bottle neck 10 of the medical active substance container 1 has a collar 101 which has a collar end bead 102, an outer collar surface 103 and an inner contact surface 104. The multi-part closure device 2 interacts with the collar end bead 102, with one part engaging behind the collar end bead 102 and one part resting against the outer collar surface 103, so that the closure device 2 cannot slip relative to the collar 101.

The sealing plug 20 is formed in one piece from an elastomer, preferably from rubber or from a thermoplastic elastomer (TPE), and is overall tapered downwards from the top, i.e. from the side facing away from the medical active substance container 1, i.e. is essentially conical in shape.

The sealing plug 20 has a profiled shape and at least one sealing lip 201 and one edge 202 are arranged on the outer circumferential side surface of the sealing plug 20. In this way, the sealing plug 20 can be pressed onto the bottle neck 10 in the longitudinal direction L and can be arranged and fastened so that it partially protrudes therein. In order to increase the tightness, three sealing lips 201 along the outer side surface of the sealing plug 20, which in the assembled state come to lie along the inner contact surface 104 of the bottle neck 10, have proven to be effective. The edge 202 projects radially beyond the tapered part of the sealing plug 20 and remains outside the bottle neck 10 in the assembled state.

The tapered part of the sealing plug 20 is inserted into the bottle neck 10 during assembly, with the edge 202 of the sealing plug 20 remaining outside the collar 101 and the bottle neck 10. A cage support surface 2021 and a circumferential cage edge recess 2022, in the form of an annular groove, are arranged along the circumferential edge 202. Preferably, the cage edge recess 2022 has a circumferential bead 2023, which is formed by an undercut in a lower section of the cage edge recess 2022 on a radially inner surface of the cage edge recess 2022.

A central plug tapering 203 is provided in the sealing plug 20, also indicated by a dashed line in FIG. 1a, to allow easy access to the interior of the medical active substance container 1 when the contents are subsequently removed. This plug tapering 203 makes it easier to push a drawing-up and/or application needle through.

In addition to the sealing plug 20, which is optimized compared to the prior art, the multi-part compact closure device 2 has a plug securing device 21 consisting of two parts, a securing cage 210 and an outer cage shell 211.

The securing cage 210, which in the assembled state is located on the inside, closer to the longitudinal axis L, is manufactured in one piece as a continuous unit, preferably from a thermoplastic material and comprises a centric ring 2101 and a circumferential side wall 2102 with a plurality of undercut webs 2103. The centric ring 2101 leaves a central opening in the securing cage 210, so that the mounting and/or application needle can be pushed through. The size of the central opening is preferably as large as the diameter of the plug tapering 203 in the sealing plug 20 or even larger. The securing cage 210 is particularly preferably made of polybutylene terephthalate (PBT).

The undercut webs 2103 are arranged in the side wall 2102 in such a way that they can be brought into engagement below the collar end bead 102 on the collar 101 in the assembled state. In the view according to FIG. 1a, an inclination from bottom to top in the direction of the longitudinal axis L is recognizable. Due to the inclination of the undercut webs 2103 in the direction of the longitudinal axis L, engagement of the undercut webs 2103 behind the collar 101 is possible.

A cage edge bead 2104 is arranged at least partially circumferentially in the side wall 2102. In the assembled state of the multi-part closure device 2, the cage edge bead 2104 is enclosed by the outer cage shell 211.

A plug engagement edge 2105 is bent over at the end of the centric ring 2101. In the assembled state, the securing cage 210 engages in the cage recess 2022 of the sealing plug 20 with the plug engagement edge 2105, whereby the securing cage 210 is fixed to the sealing plug 20, while the centric ring 2101 rests directly on the cage support surface 2021, which can be seen in FIG. 1b. Alternatively or additionally, the securing cage 210 can be fixed to the sealing plug 20 by the sealing plug 20 being firmly connected to the securing cage 210, e.g. glued, welded or by means of form closure, such as a snap fit.

The outer cage shell 211 is mounted over the securing cage 210 as part of the plug securing device 21. This cage shell 211 is preferably made of a metal sheet, although a correspondingly shaped plastic shell would also be possible. The cage shell 211 runs essentially parallel to the securing cage 210 and rests against it. The cage shell 211 is designed as an open sleeve with a central opening 2111 and an at least partially circumferential cage shell bead 2112. Once plugged together in the direction of the longitudinal axis L, the cage shell 211 can no longer be easily removed from the securing cage 210. Once plugged together in this way, the plug securing device 21 can be pressed over the sealing plug 20 and the collar 101, so that the sealing plug 20 is finally non-detachably secured to the bottle neck 10. Alternatively, the plug securing device 21 can first be placed over the sealing plug 20 and connected to it, with the assembly of the securing cage 210, cage shell 211, protective cover 22 and sealing plug 20 then being placed as a unit over the collar 101 in order to secure the plug securing device 21 to the medical active substance container 1. The cage shell 211 completely encases the securing cage 210, while only the centric surfaces at the top and bottom of the securing cage 210 and the cage shell 211 remain accessible in the assembled state and a drawing-up and/or application needle can be pushed through the central opening 2111 and the centric ring 2101 with central opening.

In an alternative embodiment, the multi-part closure device shown can be equipped without the cage shell 211.

In order to detachably fasten the additional protective cover 22 directly to the outer cage shell 211 or indirectly to the securing cage 210, additional means are provided. These additional means are either arranged directly on the securing cage 210 or, as shown in the embodiment here, directly on the outer cage shell 211. The additional means shown here is a cover engagement 2113 formed on the edge of the central opening 2111 as part of the outer cage shell 211. The cover engagement 2113 is inclined towards the longitudinal axis L, namely upwards, in the direction of the protective cover 22.

The protective cover 22 is preferably made of polycarbonate (PC) or acrylonitrile-butadiene-styrene copolymers (ABS), is generally rotationally symmetrical and has a concentric area with an engagement edge 221. However, a protective cover 22 made of metal, e.g. aluminum, is also possible. The engagement edge 221 surrounds an area of the inner surface of the cover, the surface facing the outer cage shell 211. When the protective cover 22 is mounted on the outer cage shell 211, the cover engagement 2113 engages in the engagement edge 221, whereby the protective cover 22 is held releasably on the outer cage shell 211 and forms part of the multi-part closure device 2. The protective cover 22 can be shaped as a profile and have a centric taper 222 or optional recesses 222, which lead to increased stability or are selected to save material.

The protective cover 22 is optional and not absolutely necessary. However, in order to provide better protection against external influences, the protective cover 22 should be detachably connected to the outer cage shell 211 or the securing cage 210 of the plug securing device 21, so that the protective cover 22 can be removed from the plug securing device 21 before use. To attach the protective cover 22 to the closure device 2, the protective cover 22 can also be connected to the outer cage shell 211 or the securing cage 210 by means of material closure, e.g. by laser welding. An adhesive connection or a form-fit connection is also possible, as explained above. It is also conceivable that the protective cover 22 is manufactured together with the securing cage 210 or, if present, with the outer cage shell 211 in one piece, for example as a plastic injection mold, whereby predetermined breaking points are formed for releasing the protective cover 22. Against this background, it is particularly preferable if the protective cover 22 and the securing cage 210 are made of plastic.

FIG. 1b shows the assembled state of the multi-part closure device 2. Once assembled, the undercut webs 2103 in the side wall 2102 behind the collar 101 engage concentrically at several points and the position of the sealing plug 20 on the inner contact surface 104 is secured, while the at least one sealing lip 201 closes sealingly. The side wall 2102 of the securing cage 210 and the outer cage shell 211 are in contact with the outer collar surface 103. Even when pulled in the direction of the longitudinal axis L, away from the medical active substance container 1, the securing cage 210 and thus the sealing plug 20 remain motionless.

The effect of the plug securing device 21 is maximized with little material, few components and low weight of the entire plug securing device 21.

The sealing lips 201, which project radially outwards from the sealing plug 20, are preferably three stepped sealing lips 201, i.e. arranged at different heights parallel to the longitudinal axis L, which can be seen in FIG. 1c if the bottle neck 10 is omitted.

The plug engaging edge 2105 engages in the concentric circumferential cage recesses 2022. The cage edge recesses 2022 are recessed from the sealing plug 20 at a radial angle to the longitudinal axis. The circular circumferential cage edge bead 2104 in the securing cage 210 and the parallel cage shell bead 2112 in the outer cage shell 211 are clearly recognizable and in engagement. The securing cage 210 is operatively connected to the outer cage shell 211, surrounds the sealing plug 20 and is covered by the cover 22.

Due to the special design of the cage edge recess 2022 shown here in the direction of the longitudinal axis L and the engaging plug engagement edge 2105, also inclined in the direction of the longitudinal axis L, part of the surface of the sealing plug 20, which faces the cover 22, is pressed in the direction of the outer cage shell 211, so that the outer cage shell 211 also rests firmly on the sealing plug 20.

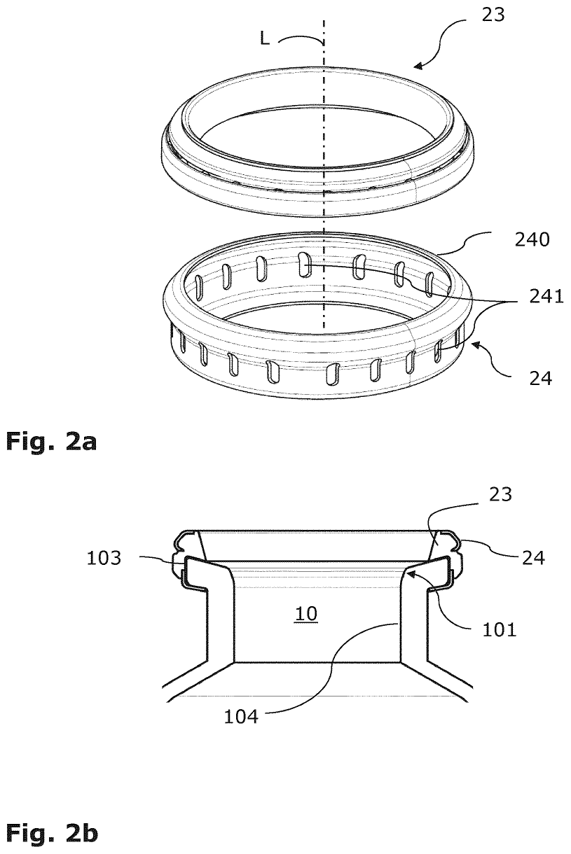

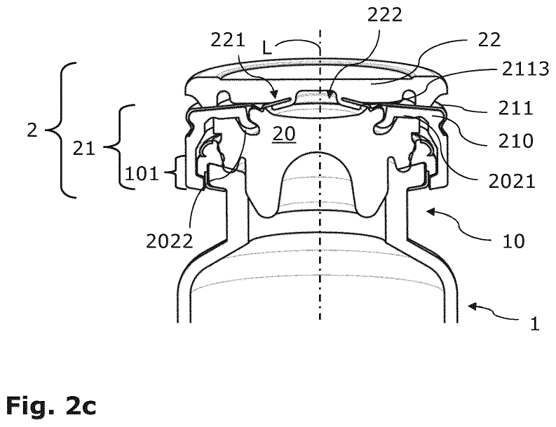

The multi-part closure device 2 can optionally be adapted for medical active substance containers 1 made of glass. Since such medical active substance containers 1 made of glass often have more simply shaped bottle necks 10 without protruding or protruding collar end beads 102, adequate fastening is often more difficult to produce. In addition to the compact multi-part closure device 2, an inner thermoplastic ring 23 and an outer metal ring 24 are preferably used, as shown in FIG. 2a. The inner thermoplastic ring 23 is preferably made of polybutylene terephthalate (PBT), while the outer metal ring 24 is made of aluminum or another metal. The thermoplastic ring 23 has a profile that matches the profile of the metal ring 24. Due to the thermoplastic design of the thermoplastic ring 23, it can be glued to the metal ring 24. The metal ring 24 has an upper collar 240, a middle section with through-holes 241 and a lower metal ring flange 242. Parts of the thermoplastic ring 23 melt through the through holes 241 during manufacture, so that the two rings 23 and 24 are inseparably joined together. This melting of the thermoplastic ring 23 onto the metal ring 24 can take place directly on the collar 101 or can have been carried out beforehand.

FIG. 2b shows the metal ring 24 and thermoplastic ring 23 mounted on the bottle neck 10 before the multi-part compact closure device 2 is pressed on. FIG. 2c shows how such a multi-part closure device 2 combined with metal ring 24 and thermoplastic ring 23 can be attached to a simplified bottle neck 10 after being pressed on in the direction of arrow L. The securing cage 210 engages with a part of the side wall 2102 under the thermoplastic ring 23 or the metal ring 24.

The advantage of the multi-part closure device 2, which can be attached to the bottle neck by pressing on and hooking, is that several unsealed medical active substance containers 1 with matching multi-part closure devices 2 and possibly with the ring combination 23, 24 can be transported unfilled and unsealed to an active substance filling system, where they can be filled and also simply closed there. Without special tools at the filling location by the active substance or vaccine filler himself.

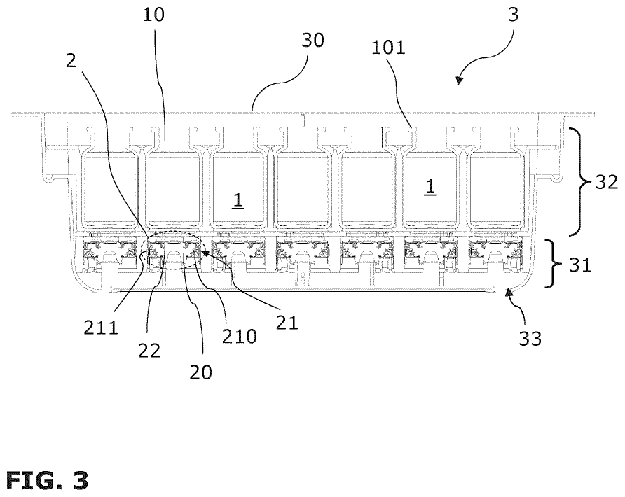

For this purpose, as shown in FIG. 3, a transport container 3, which can also be referred to as a delivery cassette 3, comprising a transport tub 33, in which a first storage pallet 31 with multi-part closure devices 2 and a second storage pallet 32 with medical active substance containers 1 are delivered closed with a box lid 30 and/or a protective film 30. The medical active substance containers 1 are unsealed, i.e. the openings of the medical active substance containers 1 at the bottle neck 10 are free. One advantage of providing the medical active substance containers 1 and their multi-part closure devices 2 in a common transport container of an active substance filling system lies, among other things, in ensuring that the closures suitable for the medical active substance containers 1 are also provided. This makes the filling process more efficient and safer, especially for large production quantities. At the same time, a high level of hygiene is guaranteed.

As explained above, the multi-part closure devices 2 shown each comprise a sealing plug 20, a plug securing device 21 with a securing cage 210, a cage shell 211 and a protective cover 22. The multi-part closure devices 2 are suitable for pressing onto and latching onto the collars 101 of the bottle necks 10 of the medical active substance containers 1. Of course, the transport tub can also be used in combination with alternative embodiments of the multi-part closure devices, for example in combination with multi-part closure devices that do not have a cage shell or a protective cover.

In particular, if the plug securing device 21 comprises the already explained securing cage 210 with the centric ring 2101, the central opening and the side wall 2102, wherein a circumferential cage edge bead 2104 is molded into the outer surface of the side wall 2102 and the plurality of integrally formed undercut webs 2103 project away from the inner surface of the side wall 2102 in the direction of the longitudinal axis L, wherein a plug engagement edge 2105 formed on the securing cage 210 engages in a cage recess 2022 on the sealing plug 20 and connects the outer metal cage shell 211 with the cage shell bead 2112 via the securing cage 210, the central opening 2111 and a cover engagement 2113 is at least partially slipped over and the protective cover 22 is thus detachably secured to the plug securing device 21 via the cover engagement 2113, the multi-part closure device 2 can be engaged particularly easily.

As FIG. 3 further shows, the second storage pallet 32 with empty medical active substance containers 1 is arranged in the transport tub above the first storage pallet 31 with the multi-part closure devices 2. In the illustrated embodiment example, the second storage pallet 32 even rests on the first storage pallet 31 with the multi-part closure devices 2. In this case, the multi-part closure devices 2 are arranged on the side of the medical active substance containers 1 facing away from the bottle necks 10. In other words, the multi-part closure devices 2 are positioned under the base of the medical active substance containers 1. Such an arrangement ensures a high degree of hygiene and sterility during transportation of the transport container 3. The fact that the multi-part closure devices 2 are arranged under the medical active substance containers 1 means, for example, that particles that could become detached from the multi-part closure devices 2 during transportation as a result of vibrations or the like cannot penetrate into the medical active substance containers 1. It is therefore also not necessary to close the medical active substance containers 1 individually for transportation. Closure by means of the box lid 30 and/or the protective film 30 is sufficient.

The multi-part closure devices 2 in the first storage pallet 31 are oriented in such a way that the sealing plug 20 is arranged in each case on the side of the protective cover 22 or the securing cage 210 facing away from the bottle necks 10, i.e, the pointed end of the conical sealing plug 20, which is inserted first into the bottle neck 10 when the medical active substance containers 1 are closed, is oriented in the same direction as the lower end or the base of the medical active substance containers 1. When the medical active substance containers 1 of the second storage pallet 32 have been filled, the first storage pallet 31 with the multi-part closure devices 2 can be positioned over the second storage pallet 32 with the filled medical active substance containers 1 for the purpose of sealing without the multi-part closure devices 2 having to be additionally reoriented, e.g. rotated, because the sealing plug 20 is already oriented with its front end in the direction of the opening of the bottle neck 10.

The arrangement of the multi-part closure devices 2 in the first storage plate 31 and the arrangement of the medical active substance containers 1 in the second storage pallet 32 are coordinated in such a way that by placing and pressing the first storage pallet 31 onto the second storage pallet 32, the multi-part closure devices 2 engage with the bottle necks 10 of corresponding medical active substance containers 1 and seal the respective medical active substance container 1. This enables quick and easy sealing of the medical active substance containers 1.

A possible filling process for the medical active substance containers 1 is as follows. First, the transport container 3 or the transport tub 33 is delivered to a filling system for active medical substances and made available to it. There, the box lid 30 and/or the protective film 30 is removed. The second storage pallet 32 with the medical active substance containers 1 is then removed from the transport tub 33 and placed in the filling station, where the open medical active substance containers 1 arranged locally in the second storage pallet 32 are filled.

As soon as all the medical active substance containers 1 of the second storage pallet 32 have been filled, the complete first storage pallet 31, which is also removed from the transport tub 33, is placed over the second storage pallet 32 so that the sealing plugs 20 come to rest on the bottle necks of the filled medical active substance containers 1. By pressing the first storage pallet 31 in the direction of the bottom of the transport tub or in the direction of the bottom of the medical active substance container 1, i.e. in the direction of the longitudinal axis L of the medical active substance container 1, each medical active substance container 1 is sealed tightly with an associated closure device 31.

When the first storage pallet 31 is pressed down, the multi-part closure devices 2 with their sealing plugs 20 and the plug securing device 21 are pressed onto the openings of the bottle necks 10. The previously explained undercut webs 2103 in the side wall 2102 of the securing cage 210 engage behind the collar end bead 102 and secure against undesired opening of the medical active substance containers 1. This ensures that they are locked in place and the multi-part closure devices 2 can no longer be easily removed.

After the active substance containers 1 have been filled and sealed, the second storage pallet 32 with the filled and sealed active substance containers 1 can be repositioned in the transport tub 33 and the transport container can be sealed with the box lid 30 and/or a protective film 30.

Alternatively, it is also possible to first remove the first and second storage pallets 31 and 32 from the transport tub 33 and then to place the second storage pallet 32 with the empty medical active substance containers 1 back into the transport tub 33, whereby the transport tub 33 is then moved together with the empty medical active substance containers 1 arranged therein into the filling station for filling. After the filled medical active substance containers 1 have been sealed, they are sealed as described above by pressing on the first storage pallet 31 with the multi-part closure devices 2. Subsequently, further transportation can also take place in the transport tub 33.

If medical active substance containers 1 made of glass are used, thermoplastic ring 23 and metal ring 24 are also fitted to the bottle neck 10 before the transport tub 33 is sealed and transported to a filling system. After filling, the multi-part closure devices 2 are pressed on as usual, in this case via the bottle neck 10 with ring combination 23, 24.

Known plastics, in particular thermoplastics, can be used as the material for the box lid 30, the storage pallets 31, 32 and the transport tub 33. A non-woven fabric made of high-density polyethylene has proven to be particularly suitable as a material for the protective film 30.

By delivering the transport container 3 with unsealed active substance containers, whereby the first storage pallet 31 and the second storage pallet 32 have matching positions of the closure devices 2 and the active substance containers 1, filling and sealing can be simplified and greatly accelerated. This filling and closing process does not have to be carried out by a specialized company and specialized equipment. Since several components are supplied for filling in one package, in this case the transport container 3, a large amount of waste and large transportation volumes can be avoided. In particular, sealing can be greatly simplified and the time required for sealing can be minimized. In addition, compliance with the necessary sterility during transportation is guaranteed.

### LIST OF REFERENCE SIGNS

1 Medical active substance containers/vial
   10 Bottle neck
   101 Collar with inner collar taper
   102 Collar end bead
   103 Outer collar surface
   104 Inner contact surface
2 Multi-part closure device
20 Sealing plugs (rubber, elastomer, self-closing)
   201 Sealing lips
   202 Edge
      2021 Cage support surface
      2022 Cage edge recess
   203 plug tapering
21 Plug securing device
   210 Securing cage (thermoplastic, PBT)
      2101 centric ring (with central opening)
      2102 Side panel
      2103 Undercut webs in side panel
      2104 Cage edge bead
      2105 Plug engagement edge (end of the centric ring circumferential,
   211 Outer cage shell (metal, surrounding sheet metal)
      2111 central opening
      2112 Cage shell bead (circumferential engagement edge, analogous to 2104)
      2113 Cover engagement (circumferential around 2111)
22 Protective cover (removable, plastic, profiled, rotationally symmetrical)
   221 Engagement edge (protruding diagonally upwards, can be effectively connected with cover engagement)
   222 centric taper/optional recess
   223 Transparent/translucent window layer
   224 Window elevations in 223
23 Thermoplastic ring
24 Metal ring
   240 upper collar
   241 Through holes
   242 Metal ring flange
3 Transport container/delivery cassette
30 Box lid/protective film
31 First storage pallet for locking devices
32 Second storage pallet for active substance containers
33 Transport tub

1. Transport tub (33) with a plurality of empty medical active substance containers (1), in particular for transporting a plurality of empty medical active substance containers (1) for filling medical active substances,
wherein a first storage pallet (31) and a second storage pallet (32) are accommodated in the transport tub (33) and the transport tub (33) is closed with a box lid (30) or a protective film (30),
wherein the first storage pallet (31) comprises a plurality of multi-part closure devices (2) and the second storage pallet (32) comprises the plurality of empty medical active substance containers (1),
wherein the multi-part closure device (2) each comprises a sealing plug (20), a plug securing device (21) with a securing cage (210) and a protective cover (22), and wherein the multi-part closure devices (2) are suitable for being pressed onto and engaging with collars (101) of bottle necks (10) of the medical active substance containers (1).

2. Transport tub (33) according to claim 1, wherein the second storage pallet (32) with empty medical active substance containers (1) is arranged in the transport tub (33) above the first storage pallet (32) and the closure devices (2) are arranged on the side of the medical active substance containers (1) facing away from the bottle necks (10).

3. Transport tub (33) according to claim 1, wherein the second storage pallet (32) rests on the first storage pallet (31), in particular rests loosely.

4. Transport tub (33) according to claim 1, wherein the multi-part closure devices (2) are arranged in the first storage pallet (31) in such a way that the sealing plug (20) is arranged in each case on the side of the securing cage (210) facing away from the bottle necks (10).

5. Transport tub (33) according to claim 1, wherein the arrangement of the multi-part closure devices (2) in the first storage plate (31) and the arrangement of the medical active substance containers (1) in the second storage pallet are matched to one another in such a way that, by placing and pressing the first storage pallet (31) onto the second storage pallet (32), the multi-part closure devices (2) engage on the bottle necks (10) and seal the respective medical active substance container (1).

6. Transport tub (33) according to claim 1, wherein the first storage pallet (31) and the second storage pallet (32) are separated from each other by a lid or a protective film.

7. Transport tub (33) according to claim 1, wherein the plug securing device (21) comprises an outer cage shell (211) which is at least partially slipped over the securing cage (210).

8. Transport tub (33) according to claim 1, wherein the plug securing device (21) comprises a protective cover (22).

9. Transport tub (33) according to claim 1, wherein a metal ring (24) and/or thermoplastic ring (23) is mounted on the bottle neck (10) of each empty medical active substance container (1) in the second storage pallet (32), wherein the securing cage (211) is adapted to engage the metal ring (24) and/or thermoplastic ring (23).

10. Transport tub (33) according to claim 1, wherein the empty medical active substance containers (1) are formed of glass.

11. Filling method for filling a plurality of medical active substance containers (1) in a second storage pallet (32) and sealing with associated multi-part closure devices (2) in a first storage pallet (31) after providing both storage pallets (31, 32) of a sealed transport tub (33) according to claim 1, at the site of the active substance filler, characterized by the steps of:
Opening the transport tub (33) by removing the box lid (30) and/or the protective film (30),
placing the second storage pallet (32) with empty medical active substance containers (1) in a filling system,
filling the active substance or vaccine into the plurality of medical active substance containers (1),
sealing the filled medical active substance containers (1) by placing and pressing on the first storage pallet (31) with multi-part closure devices (2), which are arranged in the same way as the medical active substance containers (1) in the second storage pallet (32), in the direction of the longitudinal axis (L) of the multi-part closure devices (2) or the medical active substance containers (1).

12. Filling method according to claim 11, wherein the first storage pallet (31) with the multi-part closure devices (2) and the second storage pallet (32) with the empty medical active substance containers (1) are removed from the transport tub (33) after the transport tub (33) has been opened.

13. Filling method according to claim 11, wherein the second storage pallet (32), after filling and pressing the first storage pallet (31) with closure devices (2) onto the filled medical active substance containers (1), is placed as a unit back into the transport tub (33).

14. Filling method according to claim 11, wherein the first storage pallet (31) with the multi-part closure devices (2) and the second storage pallet (32) with the empty medical active substance containers (1) are removed from the transport tub (33) after the transport tub (33) has been opened, and wherein the second storage pallet (32) is placed back in the transport tub (33) before filling and pressing the first storage pallet (31) with closure devices (2) onto the filled medical active substance containers (1).

15. Filling method according to claim 11, wherein the filled closed medical active substance containers (1) are transported away by means of the transport tub (33), wherein the transport tub (33) is closed with the box lid (30) and/or another cover, such as a protective film.
